(19) United States
(12) Patent Application Publication
(10) Pub. No.: US 2026/0225541 A1
(43) Pub. Date: Aug. 6, 2026

(54) SELECTOR SWITCH

(71) Applicant: YAZAKI CORPORATION, Tokyo (JP)

(72) Inventors: Mitsuaki Morimoto, Susono-shi (JP); Masami Ide, Susono-shi (JP)

(21) Appl. No.: 19/449,393

(22) Filed: Jan. 14, 2026

(30) Foreign Application Priority Data
Feb. 5, 2025 (JP) 2025-017318

(51) Int. Cl. B60R 16/00; B60L 58/19; H01H 15/06

(52) U.S. Cl. CPC B60R 16/005; B60L 58/19; H01H 15/06; H01H 2207/026; H01H 2227/036

(57) ABSTRACT

A selector switch for switching a connection state between a first power source and a second power source into series connection or parallel connection, includes a fixed conductive unit provided with a series-use breaking point and a parallel-use breaking point, and a movable connection unit including a series-use terminal and a parallel-use terminal, wherein when the movable connection unit is positioned at a first position, the parallel-use breaking point remains disconnected, and the series-use breaking point is connected to be in a conductive state, whereby the first power source and the second power source are connected in series, and when the movable connection unit is positioned at a second position, the series-use breaking point remains disconnected, and the parallel-use breaking point is connected to be in a conductive state, thereby connecting the first power source and the second power source in parallel.

### TECHNICAL FIELD

The present invention relates to a selector switch.

### BACKGROUND

In recent years, the voltage of batteries mounted in electric vehicles (EVs) and the like has been increasing, and products whose voltage is approximately twice that of conventional batteries have been made available. Meanwhile, although some fast chargers comply with standards that can accommodate high-voltage batteries, it is difficult for all fast chargers to support such high voltages. To address this issue, vehicle-mounted systems have been proposed that include a configuration capable of switching between a series circuit, which enables the battery to support high voltages, and a parallel circuit, which enables the battery to support low voltages (see, for example, Patent Document 1). The power supply system described in Patent Document 1 includes a charging switching unit composed of relays that can switch between the series circuit and the parallel circuit.

### RELATED ART

### Patent Document

Patent Document 1: JP2020150784 A

### SUMMARY OF THE INVENTION

### Problem to be Solved by the Invention

However, the relays used in the power supply system described in Patent Document 1 often include multiple mechanical relays. For example, because a mechanical relay is configured with a coil section, fixed contacts, movable contacts, and the like housed within a cubic case, a box-shaped space is required for installation, which tends to increase the height of the device in which it is installed. Furthermore, in such a configuration, if multiple mechanical relays are inadvertently turned on simultaneously, there is a possibility that a short circuit may occur in the electrical circuit.

It is an object of the present invention to provide a selector switch that contributes to reducing the height of the device while alleviating short circuits.

### Solution to Problem

In order to solve the above problems and achieve the object, a selector switch for switching a connection state between a first power source and a second power source into series connection or parallel connection, including:

a fixed conductive unit that constitutes a part of an electrical circuit connecting the first power source and the second power source; and

a movable connection unit that moves in a predetermined direction,

wherein the movable connection unit includes a series-use terminal that forms the series circuit of the electrical circuit, and a parallel-use terminal that forms the parallel circuit of the electrical circuit,

the fixed conductive unit is provided with a series-use breaking point, a part of which is interrupted, and a parallel-use breaking point, a part of which different from the series-use breaking point is interrupted,

when the movable connection unit is positioned at a first position in the predetermined direction, the parallel-use breaking point remains disconnected in a non-conductive state, and the series-use breaking point is connected by the series-use terminal to be in a conductive state, whereby the first power source and the second power source are connected in series, and

when the movable connection unit is positioned at a second position in the predetermined direction, the series-use breaking point remains in a disconnected, non-conductive state, and the parallel-use breaking point is connected by the parallel-use terminal to become conductive, thereby connecting the first power source and the second power source in parallel.

### Advantageous Effects of the Invention

According to the present invention, a selector switch that contributes to reducing the height of the device while alleviating short circuits can be provided.

### BRIEF DESCRIPTION OF THE DRAWINGS

FIG. 1 is a perspective view of an entire selector switch according to an embodiment.

FIG. 2 is an exploded perspective view of the selector switch illustrated in FIG. 1.

FIG. 3 is a schematic diagram of a series circuit in a conductive state.

FIG. 4 is a schematic diagram of a parallel circuit in a conductive state.

FIG. 5A is a plan view illustrating a part of the selector switch in which the series circuit is in a conductive state.

FIG. 5B is a cross-sectional view taken along line A-A in FIG. 5A.

FIG. 5C is a cross-sectional view taken along line B-B in FIG. 5A.

FIG. 6A is a plan view illustrating a part of the selector switch in which the parallel circuit is in a conductive state.

FIG. 6B is a cross-sectional view taken along line C-C in FIG. 6A.

FIG. 6C is a cross-sectional view taken along line D-D in FIG. 6A.

FIG. 7A is a cross-sectional view illustrating a movable connection unit while the conduction destination is being switched.

FIG. 7B is a cross-sectional view illustrating the movable connection unit in a conductive state.

### DETAILED DESCRIPTION OF THE EXEMPLARY EMBODIMENT

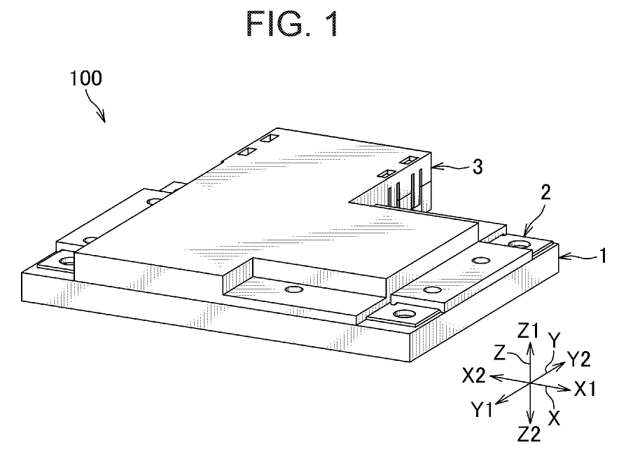

The selector switch 100 is hereinafter described. The selector switch 100 is mounted, for example, in an electric vehicle (EV) equipped with a high-voltage battery, and performs an operation of switching the high-voltage battery in the vehicle between series connection and parallel connection. As illustrated in FIG. 1, the selector switch 100 includes a base 1 that constitutes the bottom portion, a conductive unit 2 accommodated in the base 1, and a cover 3 that covers the conductive unit 2.

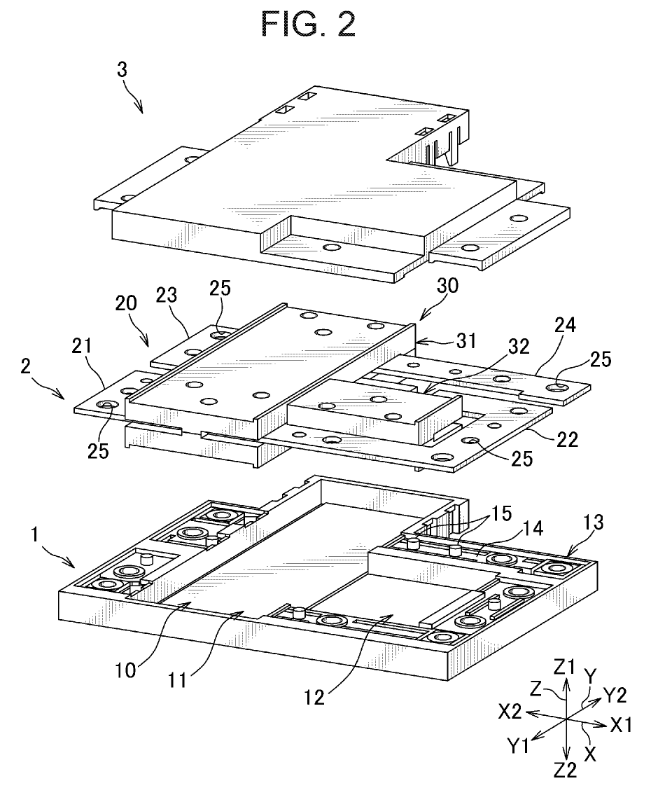

In the drawings, the height direction of the selector switch 100 is indicated by a reference symbol Z. One side in a "height direction Z" is defined as an "upper side Z1", and the other side is defined as a "lower side Z2". One of the directions orthogonal to the height direction Z is defined as a front-and-rear direction and is indicated by a reference symbol X. One side in the "front-and-rear direction X" is defined as a "front side X1", and the other side is defined as a "rear side X2". The direction orthogonal to both the height direction Z and the front-and-rear direction X is defined as a left-and-right direction, and is indicated by a reference symbol Y. One side in the "left-and-right direction Y" is defined as a "left side Y1", and the other side is defined as a "right side Y2". In this embodiment, the left-and-right direction Y is a sliding direction (predetermined direction) in which the movable connection unit 30 (see FIG. 2) slides, and the front-and-rear direction X is an intersecting direction. These definitions of directions are provided for the sake of convenience in description and do not limit the orientation of the selector switch 100 during assembly or use.

First, the base 1 and the cover 3 are hereinafter described. As illustrated in FIG. 2, the base 1 is formed in a substantially rectangular plate shape. At the center of the base 1, an accommodating portion 10 is formed to accommodate the movable connection unit 30 so as to be slidable in the left-and-right direction Y. The accommodating portion 10 is composed of a rear space 11 and a front space 12. The rear space 11 is formed in a rectangular box shape, extends from the edge on the left side Y1 of the base 1 toward the right side Y2, and projects from the edge on the right side Y2 of the base 1 toward the right side Y2. The front space 12 is also formed in a rectangular box shape and extends toward the front side X1 while being in communication with the rear space 11. Around the accommodating portion 10, a mounting portion 13 is formed for installing a fixed conductive unit 20, which will be described later. The mounting portion 13 includes a mounting surface 14 that faces upward (toward the upper side Z1) and surrounds the upper edge of the accommodating portion 10. A plurality of fixing projections 15 protruding upward (toward the upper side Z1) are formed on the upper surface of the mounting surface 14. The cover 3 is formed in a box shape so as to cover the entire accommodating portion 10 and part of the mounting portion 13.

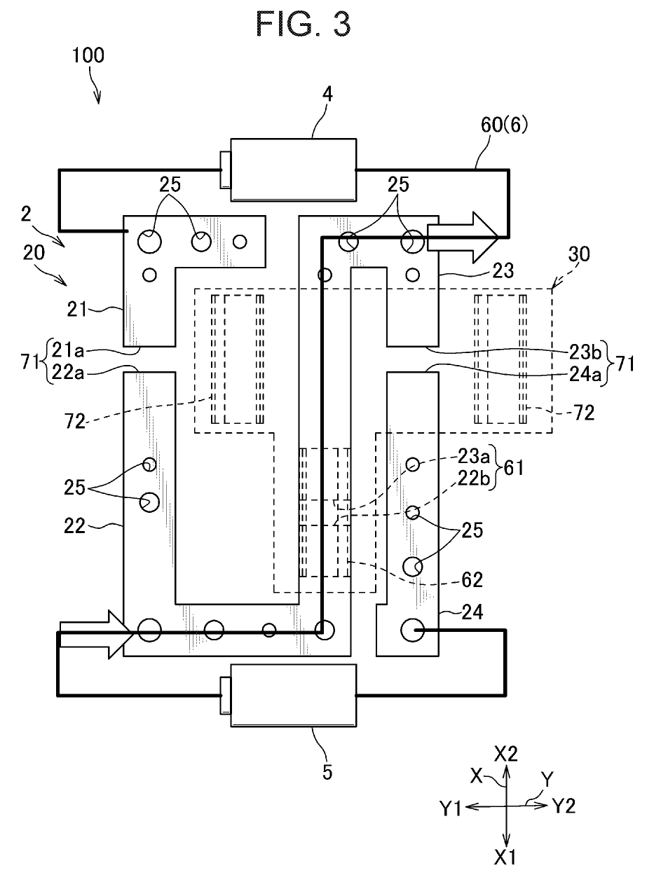

Next, the conductive unit 2 is hereinafter described. As illustrated in FIG. 3, the conductive unit 2 connects a first battery 4 (first power source) and a second battery 5 (second power source) to form a part of an electrical circuit 6. The conductive unit 2 includes a fixed conductive unit 20, which is fixed to the mounting surface 14 of the base 1, and a movable connection unit 30, which is slidable in the left-and-right direction Y relative to the fixed conductive unit 20. The fixed conductive unit 20 includes a plurality of plate-shaped bus bars. Specifically, as illustrated in FIG. 3, the bus bars include an inverted L-shaped bus bar 21 arranged at the rear-left side and an L-shaped bus bar 22 arranged on the front side X1 of the inverted L-shaped bus bar 21. The inverted L-shaped bus bar 21 is connected to the positive terminal side of the first battery 4, and the L-shaped bus bar 22 is connected to the positive terminal side of the second battery 5.

The fixed conductive unit 20 further includes a hook-shaped bus bar 23 arranged on the rear side of the L-shaped bus bar 22 and a straight bus bar 24 arranged on the front side X1 of the hook-shaped bus bar 23. The hook-shaped bus bar 23 is connected to the negative terminal side of the first battery 4, and the straight bus bar 24 is connected to the negative terminal side of the second battery 5. The inverted L-shaped bus bar 21, the L-shaped bus bar 22, the hook-shaped bus bar 23, and the straight bus bar 24 each have a fixing hole 25 that penetrates in the thickness direction. By inserting the fixing projections 15 of the base 1 into the fixing holes 25, the inverted L-shaped bus bar 21, the L-shaped bus bar 22, the hook-shaped bus bar 23, and the straight bus bar 24 are positioned relative to the mounting surface 14 and fixed to the mounting surface 14.

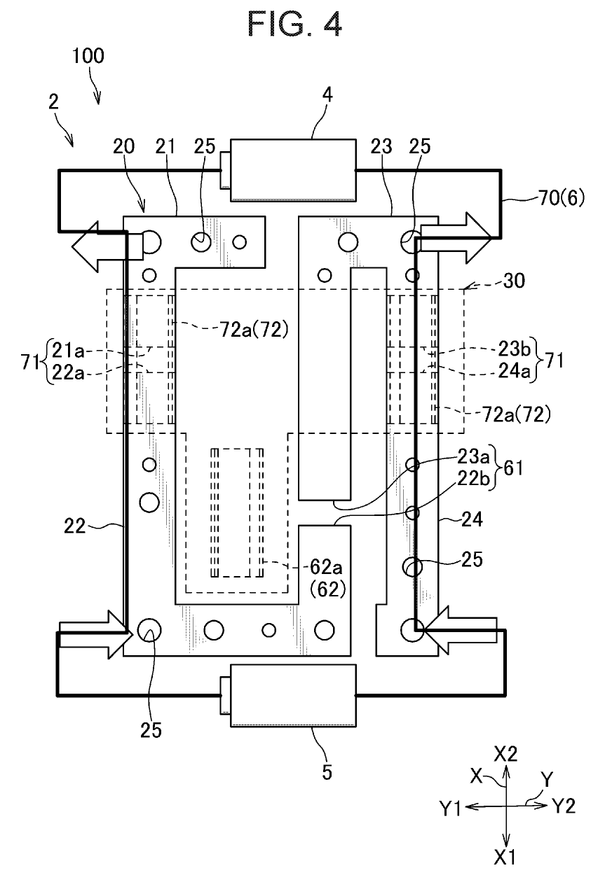

By switching the connection destinations of the inverted L-shaped bus bar 21, the L-shaped bus bar 22, the hook-shaped bus bar 23, and the straight bus bar 24, it is possible to configure the series circuit 60 illustrated in FIG. 3 and the parallel circuit 70 illustrated in FIG. 4. An end portion 21a (first end portion) of the inverted L-shaped bus bar 21, which faces the front side X1, and an end portion 22a on the left side Y1 (second end portion) of the L-shaped bus bar 22, which faces the rear side X2, are spaced apart in the front-and-rear direction X (intersecting direction) and face each other. These end portions 21a and 22a are connected by a parallel-use terminal 72, which will be described later, to form a parallel-use breaking point 71 for constituting the parallel circuit 70.

Further, the end portion 22b (first end portion) on the right side Y2 of the L-shaped bus bar 22, which faces the rear side X2, and the left side Y1 end portion 23a (second end portion) of the hook-shaped bus bar 23, which faces the front side X1, are spaced apart in the front-and-rear direction X (intersecting direction) and face each other. These end portions 22b and 23a are connected by a series-use terminal 62, which will be described later, to form a series-use breaking point 61 for constituting the series circuit 60. In addition, the end portion 23b (first end portion) on the right side Y2 of the hook-shaped bus bar 23, which faces the front side X1, and the end portion 24a (second end portion) of the straight bus bar 24, which faces the rear side X2, are spaced apart in the front-and-rear direction X (intersecting direction) and face each other. These end portions 23b and 24a are connected by a parallel-use terminal 72, which will be described later, to form the parallel-use breaking point 71 for constituting the parallel circuit 70.

As described above, end portions 21a, 22b, and 23b (first end portions) of one of the plurality of bus bars and end portions 22a, 23a, and 24a (second end portions) of the other of the plurality of bus bars are spaced apart in the front-and-rear direction X (intersecting direction) and face each other to form the series-use breaking point 61 or the parallel-use breaking point 71. Thus, the fixed conductive unit 20 is provided with the series-use breaking point 61, a part of which is interrupted, and a parallel-use breaking point 71, a part of which different from the series-use breaking point 61 is interrupted. In the present embodiment, two parallel-use breaking points 71 are arranged side by side in the left-and-right direction Y (sliding direction, predetermined direction), and the series-use breaking point 61 is arranged between the two parallel-use breaking points 71 in the left-and-right direction Y.

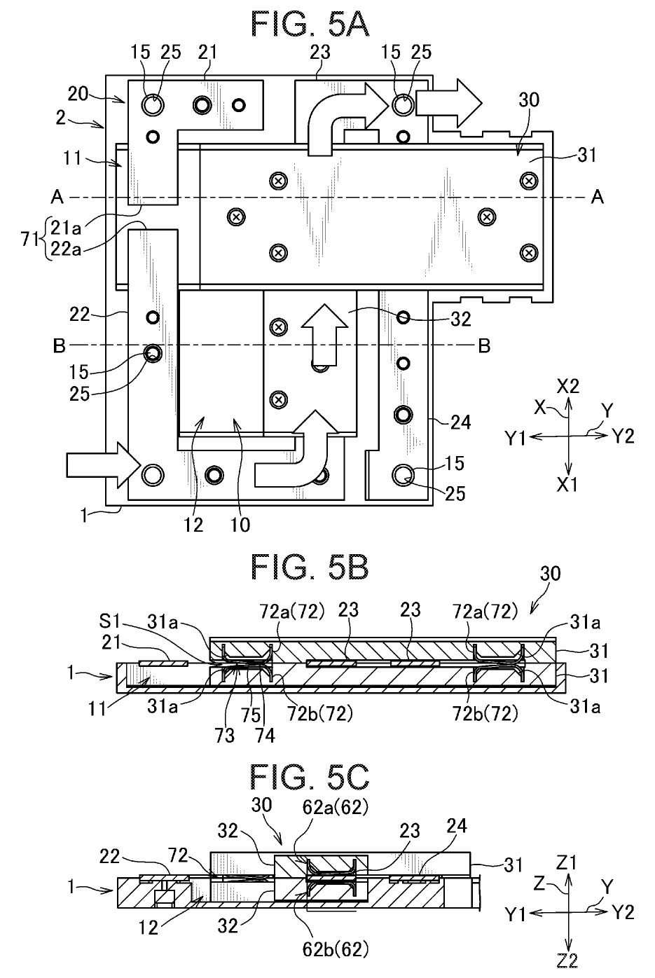

Next, the movable connection unit 30 is hereinafter described. As illustrated in FIG. 2, the movable connection unit 30 is a member that sandwiches the fixed conductive unit 20 from the upper side Z1 and the lower side Z2, and is accommodated in the accommodating portion 10 of the base 1 so as to be slidable in the left-and-right direction Y (slidable linearly). The movable connection unit 30 includes a rear slider 31, which is accommodated in the rear space 11 of the base 1, and a front slider 32, which is accommodated in the front space 12. As illustrated in FIG. 5A, the rear slider 31 is composed of two rectangular plates whose size in the left-and-right direction Y is smaller than the rear space 11, and they form a pair on the upper side Z1 and the lower side Z2 of the fixed conductive unit 20. As illustrated in FIG. 5B, the rear slider 31 on the upper side Z1 and the rear slider 31 on the lower side Z2 are each provided with a protruding convex portion 31a that projects toward each other. Two convex portions 31a are formed at intervals in the left-and-right direction Y.

The parallel-use terminal 72 for connecting the parallel-use breaking point 71 described above is provided at a position covering the convex portions 31a. The parallel-use terminal 72 on the upper side Z1 forms an upper terminal 72a. The upper terminal 72a contacts the upper side Z1 surfaces (upper surfaces) of the end portions 21a and 23b (first end portions) and the end portions 22a and 24a (second end portions) of the bus bars constituting the parallel-use breaking point 71. The parallel-use terminal 72 on the lower side Z2 forms a lower terminal 72b. The lower terminal 72b contacts the lower side Z2 surfaces (lower surfaces) of the end portions 21a and 23b (first end portions) and the end portions 22a and 24a (second end portions) of the bus bars constituting the parallel-use breaking point 71.

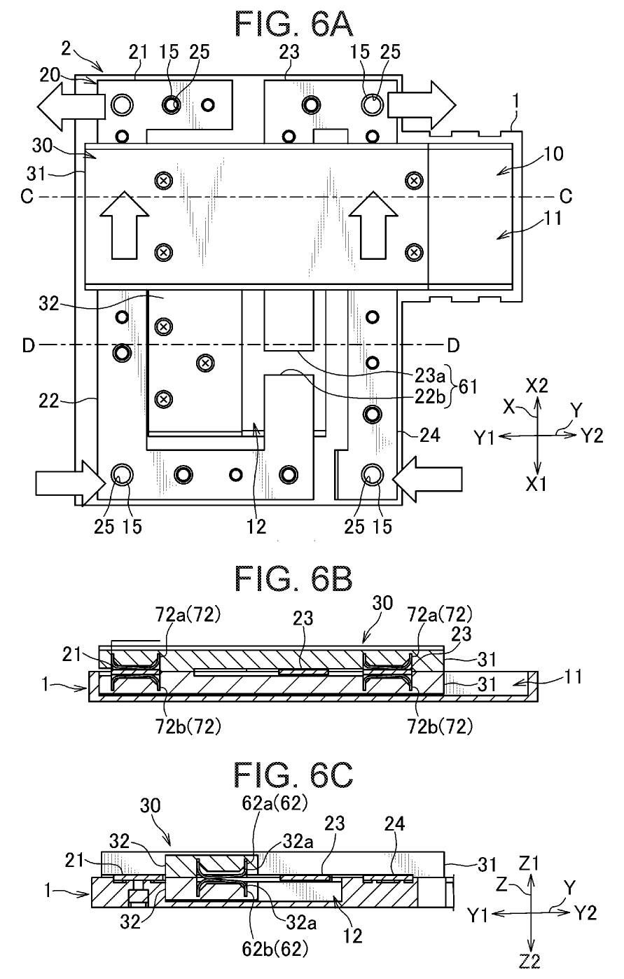

Next, the front slider 32 is hereinafter described. As illustrated in FIG. 6A, the front slider 32 is composed of two rectangular plates whose size in the left-and-right direction Y is smaller than the size of the rear slider 31, and it is integrally formed with the rear slider 31. The front slider 32 on the upper side Z1 with respect to the fixed conductive unit 20 and the front slider 32 on the lower side Z2 with respect to the fixed conductive unit 20 form a pair. As illustrated in FIG. 6C, the front slider 32 on the upper side Z1 and the front slider 32 on the lower side Z2 each have a convex portion 32a protruding toward each other. The convex portion 32a is formed in the left-and-right direction Y between the two convex portions 31a of the rear slider 31 described above. At a position covering the convex portion 32a, the series-use terminal 62 for connecting the series-use breaking point 61, as illustrated in FIG. 6A, is provided. The series-use terminal 62 on the upper side Z1 forms an upper terminal 62a. The upper terminal 62a contacts the surfaces (upper surfaces) on the upper side Z1 of the end portion 22b (first end portion) and the end portion 23a (second end portion) of the bus bars constituting the series-use breaking point 61. The series-use terminal 62 on the lower side Z2 forms the lower terminal 62b. The lower terminal 62b contacts the surfaces (lower surfaces) on the lower side Z2 of the end portions 22b and 23a of the bus bars constituting the series-use breaking point 61.

Next, the structure of the series-use terminal 62 and the parallel-use terminals 72 are hereinafter described in more detail. The upper terminal 62a and the lower terminal 62b of the series-use terminal 62, as well as the upper terminal 72a and the lower terminal 72b of the parallel-use terminal 72, have the same structure except for differences in arrangement, orientation, or whether they are displaceable in the height direction Z. Therefore, in the following description, the upper terminal 62a of the series-use terminal 62 will be taken as an example for detailed explanation, and the detailed descriptions of the lower terminal 62b of the series-use terminal 62, and the upper terminal 72a and the lower terminal 72b of the parallel-use terminal 72 will be omitted or simplified.

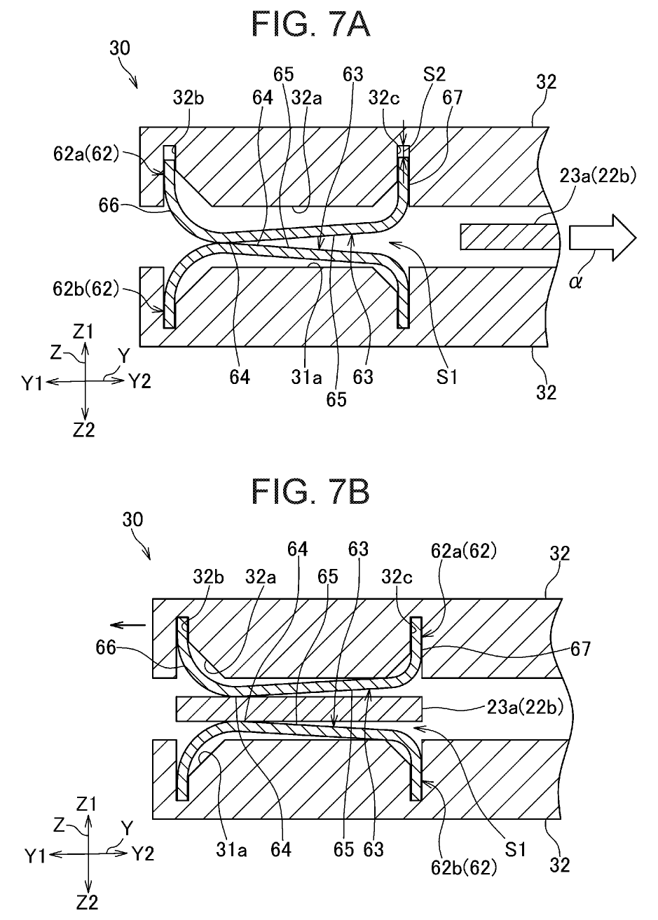

As illustrated in FIG. 4, the upper terminal 62a has a size in the front-and-rear direction X that is greater than the spacing between the end portions 22b and 23a of the bus bars. As illustrated in FIG. 7A, the upper terminal 62a includes a contact surface portion 63 having a predetermined width in the left-and-right direction Y. The contact surface portion 63 is inclined in such an angle that the portion on the left side Y1 is positioned toward the lower side Z2 with respect to the left-and-right direction Y. Consequently, the portion on the right side Y2 (one widthwise end) of the contact surface portion 63 of the upper terminal 62a is inclined in a direction away from the portion on the right side Y2 (one widthwise end) of the contact surface portion 63 of the lower terminal 62b. Due to this inclination, an opening S1 facing the right side Y2 (sliding direction) is formed at the portions on the right sides Y2 of the two contact surface portions 63. That is, the ends of the contact surface portions 63 in the width direction form the opening S1 facing the sliding direction. It is preferable that the size of the opening S1 in the height direction Z be set to be greater than the thickness of the bus bars. The end portion on the left side Y1 of the contact surface portion 63 constitutes a contact point 64 that contacts the surfaces on the upper side Z1 of the end portions 22b and 23a of the bus bars. In other words, the upper terminal 62a at least partially contacts the surfaces of the first and second end portions. As illustrated in FIG. 7A, in a non-conductive state where the upper terminal 62a does not contact the surfaces on the upper side Z1 of the end portions 22b and 23a of the bus bars, the contact point 64 is in contact with the contact point 64 of the lower terminal 62b.

A portion on the right side Y2 of the contact point 64 forms a guide surface portion 65 that extends in the left-and-right direction Y while being inclined. The guide surface portion 65 is slidable along the end portions 22b and 23a of the bus bars, and this sliding guides the end portions 22b and 23a of the bus bars to the contact point 64. A first curved portion 66, which curves and extends toward the upper side Z1, is formed at the end portion on the left side Y1 of the contact surface portion 63. An upper end of the first curved portion 66 is accommodated in a first groove portion 32b formed between the lower surface of the front slider 32 and the convex portion 32a. A second curved portion 67, which curves and extends toward the upper side Z1, is formed at the end portion on the right side Y2 of the contact surface portion 63. An upper end of the second curved portion 67 is accommodated in a second groove portion 32c formed between the lower surface of the front slider 32 and the convex portion 32a. As illustrated in FIG. 7A, a gap S2 in the height direction Z is formed between the upper terminal 62a and the front slider 32 in the non-conductive state. As illustrated in FIG. 7B, in the conductive state where the upper terminal 62a contacts the surfaces on the upper side Z1 of the end portions 22b and 23a of the bus bars, the upper terminal 62a is displaced toward the upper side Z1 by the amount of the gap S2 compared to the non-conductive state. That is, the upper terminal 62a (contact point 64) is capable of relative displacement in the height direction Z (the thickness direction of the first and second end portions).

Next, the operation of the selector switch 100 is hereinafter described. The selector switch 100 is operated by a driving unit (not illustrated) that drives the movable connection unit 30 to slide in the left-and-right direction Y, thereby switching the connection state between the first battery 4 and the second battery 5 into series connection or parallel connection. First, as illustrated in FIG. 5A, when the movable connection unit 30 is slid to the rightmost Y2 position (first position), the following occurs. That is, as illustrated in FIG. 3, the series-use breaking point 61, which is formed by the end portion 22b of the L-shaped bus bar 22 and the end portion 23a of the hook-shaped bus bar 23, is connected by the series-use terminal 62. This connection places the series-use breaking point 61 in a conductive state. On the other hand, the parallel-use breaking point 71 on the left side Y1 and the parallel-use breaking point 71 on the right side Y2 are not connected to the parallel-use terminal 72 and remain in a disconnected, non-conductive state. With this combination of connection and disconnection, the first battery 4 and the second battery 5 are connected in series, forming the series circuit 60 within the selector switch 100.

When the movable connection unit 30 is moved toward the left side Y1 from this state and slid to the leftmost Y1 position (second position), as illustrated in FIG. 6A, the conductive state of the series-use breaking point 61 is released. As a result, the series-use breaking point 61 returns to a disconnected, non-conductive state. Meanwhile, in this state, as illustrated in FIG. 4, the parallel-use breaking point 71 formed by the end portion 21a of the inverted L-shaped bus bar 21 and the end portion 22a of the L-shaped bus bar 22 is connected by the parallel-use terminal 72 on the left side Y1 and becomes conductive. In addition, the parallel-use breaking point 71 formed by the end portion 23b of the hook-shaped bus bar 23 and the end portion 24a of the straight bus bar 24 is connected by the parallel-use terminal 72 on the right side Y2 and becomes conductive. Through this combination of connection and disconnection, the first battery 4 and the second battery 5 are connected in parallel, thereby forming the parallel circuit 70 within the selector switch 100.

During switching between the series circuit 60 and the parallel circuit 70, the selector switch 100 operates as follows. For simplicity of explanation, an example is given below in which the end portion 23a of the hook-shaped bus bar 23 is connected to the series-use terminals 62 (the upper terminal 62a and the lower terminal 62b). However, the same operation occurs when other end portions of the bus bars are connected to the series-use terminal 62 or the parallel-use terminal 72. First, as illustrated in FIG. 7A, in the non-conductive state in which the contact points 64 of the series-use terminals 62 (the upper terminal 62a and the lower terminal 62b) are not in contact with the end portion 23a, the contact point 64 on the upper side Z1 and the contact point 64 on the lower side Z2 are in mutual contact with each other. Then, as the front slider 32 moves rightward in the Y2 direction, as indicated by the hollow arrow α in FIG. 7A, the portion on the left side Y1 of the end portion 23a enters between the upper terminal 62a and the lower terminal 62b.

During this entry process, the surface on the upper side Z1 of the end portion 23a slidably contacts the guide surface portion 65 of the upper terminal 62a, and the surface on the lower side Z2 of the end portion 23a slidably contacts the guide surface portion 65 of the lower terminal 62b. This state in which sliding contact occurs is referred to as the "guiding state". In the guiding state, the above sliding contact causes the upper terminal 62a to be displaced upward in the Z1 direction by being pushed by the end portion 23a. The end portion 23a is thereby guided toward the contact point 64. In this embodiment, the opening S1 facing the right side Y2 (the sliding direction) is provided at the portions on the right side Y2 of the two contact surface portions 63. Therefore, even if there is some displacement in the height direction Z between the end portion 22b and its mating end portion 23a, as illustrated in FIG. 6A, such displacement does not significantly affect the operation. That is, the end portion 22b and the end portion 23a can reliably enter between the upper terminal 62a and the lower terminal 62b. Furthermore, the end portion 22b and the end portion 23a can be guided by the guide surface portions 65.

Once the above guiding by the guide surface portion 65 is completed, the contact point 64 comes into contact with the end portion 23a and reaches a conductive state. In this conductive state, the displacement amount of the upper terminal 62a may be adjusted so that the upper terminal 62a and the lower terminal 62b come into contact with the end portions 22b and 23a in a pressed state. By doing so, positional misalignment between the fixed conductive unit 20 and the movable connection unit 30 can be alleviated, and the conductive state between the fixed conductive unit 20 and the movable connection unit 30 can be stably maintained. In addition, in this configuration, the sliding-contact portions between the fixed conductive unit 20 and the movable connection unit 30 are scraped by friction. As a result, debris or contaminants on the sliding-contact portions can be removed, providing a so-called cleaning effect.

According to the above-described embodiment, by moving the single movable connection unit 30 in the left-and-right direction Y (the predetermined direction) between the rightmost Y2 position (first position) and the leftmost Y1 position (second position), the following can be achieved. That is, the connection state between the first battery 4 (first power source) and the second battery 5 (second power source) can be switched between series and parallel. Therefore, in the direction other than the left-and-right direction Y (for example, the height direction Z), a device in which the selector switch 100 is installed can be reduced in size. In this configuration, the conductive states of the series-use breaking point 61 and the parallel-use breaking points 71 are switched according to the different positions of the single movable connection unit 30. Accordingly, simultaneous connection of the series-use breaking point 61 and the parallel-use breaking points 71 cannot occur. As a result, short circuits caused by simultaneous connection of the respective breaking points can be prevented. Thus, the selector switch 100 is provided that contributes to reducing the thickness of the device while alleviating short circuits.

Further, according to the present embodiment, by linearly sliding the movable connection unit 30, the conductive state between the first battery 4 and the second battery 5 can be easily switched. In addition, by constructing the fixed conductive unit 20 with plate-shaped bus bars, the size in the plate-thickness direction (height direction Z) can be more easily reduced compared with a configuration using conventional mechanical relays that require a box-shaped space. As a result, the device in which the selector switch 100 is installed can be made thinner.

Further, according to the present embodiment, the series-use terminal 62 and the parallel-use terminals 72 can contact the end portions 21a, 23b, and 22b (first end portions) and the end portions 22a, 24a, and 23a (second end portions) via the upper terminals 62a (upper terminals 72a) and the lower terminals 62b (lower terminals 72b). As a result, the series-use terminal 62 and the parallel-use terminals 72 can stably maintain a connected state of the series-use breaking point 61 and the parallel-use breaking point 71. Moreover, by establishing such contact, the contact surface area between the series-use terminal 62 or the parallel-use terminals 72 and the bus bars can be increased. Consequently, in the selector switch 100, a large current corresponding to a high-voltage battery can be carried while alleviating heat generation and the like.

Further, according to the present embodiment, in the movable connection unit 30, the opening S1 facing the right side Y2 (sliding direction) is provided at the right side Y2 portions (one widthwise end) of the two contact surface portions 63. Therefore, even if the positions of the end portions 22b and 23a (end portions of the bus bar) are slightly misaligned in the height direction Z, these end portions 22b and 23a can enter between the upper terminal 62a and the lower terminal 62b while absorbing such misalignment. Moreover, the end portions 22b and 23a can be guided by the guide surface portion 65. As a result, the upper terminal 62a and the lower terminal 62b can reliably contact the bus bar end portions. As described above, the configuration and effect of the opening S1 have been described with reference to the upper terminal 62a of the series-use terminal 62. However, this configuration and effect similarly apply to the parallel-use terminals 72. For example, as shown in FIG. 5B, the parallel-use terminals 72 are also each provided with an opening S1, contact surface portions 73, contact points 74, and guide surface portions 75. This arrangement allows any misalignment of the bus bar end portions to be absorbed, ensuring reliable contact of the bus bar end portions with the contact point 74.

Further, according to the present embodiment, during conduction between the fixed conductive unit 20 and the movable connection unit 30, when transitioning from the non-conductive state to the guiding state and then to the conductive state, the fixed conductive unit 20 is pressed by the upper terminal 62a and the lower terminal 62b. Therefore, misalignment between the fixed conductive unit 20 and the movable connection unit 30 is unlikely, and the conductive state between the fixed conductive unit 20 and the movable connection unit 30 can be stably maintained. Moreover, according to this configuration, during sliding contact between the upper terminal 62a and the bus bar and between the lower terminal 62b and the bus bar, debris or contaminants on the sliding contact portions between the movable connection unit 30 and the bus bars can be scraped by friction. Accordingly, a so-called cleaning effect can be expected, and the connection stability between the movable connection unit 30 and the bus bars can be maintained.

Further, according to the present embodiment, the single series-use breaking point 61 is arranged between the two parallel-use breaking points 71. With this configuration, the series circuit 60 and the parallel circuit 70 can coexist without stacking multiple bus bars, thereby alleviating an increase of the selector switch 100 in size.

It should be noted that the embodiment described above merely illustrates one example of the selector switch 100, and the present invention is not limited to this embodiment. For example, in the present embodiment, the movable connection unit 30 is configured to slide linearly, but this is merely illustrative, and the movement direction of the movable connection unit 30 is not limited to a single direction; it may also be rotational or in any other suitable direction. In addition, in the present embodiment, of the upper terminal 62a and the lower terminal 62b, the upper terminal 62a is configured to be displaceable toward the upper side Z1, but the embodiment is not limited thereto, and the lower terminal 62b may instead be configured to be displaceable toward the lower side Z2. That is, the upper terminal 62a and the lower terminal 62b may be configured to be relatively displaceable with respect to the thickness direction of the bus bars. Furthermore, instead of relative displacement, the upper terminal 62a and the lower terminal 62b may, for example, be configured as a leaf spring or the like so as to be relatively deformable.

The fixed conductive unit 20 may be made of a conductive material other than bus bars. However, compared to, for example, electric wires, using bus bars makes it less likely that the fixed conductive unit 20 will be displaced or deformed when connected to the movable connection unit 30. Therefore, from the viewpoint of stable switching operation, it is preferable to use bus bars. In the present embodiment, the driving unit for driving the movable connection unit 30 is not illustrated. However, the driving unit may have various configurations. For example, a motor unit including a motor and a pinion gear that rotates in accordance with the motor may be provided, and a rack gear meshing with the pinion gear may be formed on the edge of the rear slider 31 or the front slider 32. Such a configuration may be used as the driving unit.

The driving unit may also utilize magnetic force. In addition, the driving unit may be configured to manually displace the movable connection unit 30. In this case, for example, a handle for the operator may be formed on the movable connection unit 30, and a guide groove or the like for defining the displacement direction of the handle may be formed on the cover 3 or the like. Since the rear slider 31 and the front slider 32 are integrally formed as described above, when providing the driving unit, it is not necessary to provide separate driving units for each slider; a single driving unit is sufficient.

### List of Reference Signs

4 first battery (first power source)

5 second battery (second power source)

6 electrical circuit

20 fixed conductive unit

30 movable connection unit

61 series-use breaking point

62 series-use terminal

71 parallel-use breaking point

72 parallel-use terminal

100 selector switch

1. A selector switch for switching a connection state between a first power source and a second power source into series connection or parallel connection, comprising:
a fixed conductive unit that constitutes a part of an electrical circuit connecting the first power source and the second power source; and
a movable connection unit that moves in a predetermined direction,
wherein the movable connection unit includes a series-use terminal that forms a series circuit in the electrical circuit, and a parallel-use terminal that forms a parallel circuit in the electrical circuit,
the fixed conductive unit is provided with a series-use breaking point, a part of which is interrupted, and a parallel-use breaking point, a part of which different from the series-use breaking point is interrupted,
when the movable connection unit is positioned at a first position in the predetermined direction, the parallel-use breaking point remains disconnected in a non-conductive state, and the series-use breaking point is connected by the series-use terminal to be in a conductive state, whereby the first power source and the second power source are connected in series, and
when the movable connection unit is positioned at a second position in the predetermined direction, the series-use breaking point remains disconnected in a non-conductive state, and the parallel-use breaking point is connected by the parallel-use terminal to be in a conductive state, thereby connecting the first power source and the second power source in parallel.

2. The selector switch according to claim 1, wherein the movable connection unit moves linearly in a sliding manner,
the predetermined direction is a sliding direction of the movable connection unit, and
the fixed conductive unit includes a plurality of bus bars in a plate shape.

3. The selector switch according to claim 2, wherein
one of the plurality of bus bars includes a first end portion,
another of the plurality of bus bars includes a second end portion,
the first end portion and the second end portion are spaced apart in a direction intersecting the sliding direction and face each other to constitute the series-use breaking point or the parallel-use breaking point,
the series-use terminal and the parallel-use terminal have a length greater than the distance between the first end portion and the second end portion, and
each of the series-use terminal and the parallel-use terminal includes:
an upper terminal at least a part of which contacts upper surfaces of the first end portion and the second end portion; and
a lower terminal at least a part of which contacts lower surfaces of the first end portion and the second end portion, and
the upper terminal and the lower terminal form a pair.

4. The selector switch according to claim 3, wherein the upper terminal and the lower terminal are each provided with a contact surface portion having a predetermined width in the sliding direction, one widthwise end of the contact surface portion of the upper terminal and one widthwise end of the contact surface portion of the lower terminal being inclined in a direction away from each other,
an opening facing the sliding direction is formed between the one widthwise end of the contact surface portion of the upper terminal and the one widthwise end of the contact surface portion of the lower terminal, and
one of the plurality of bus bars enters the opening.

5. The selector switch according to claim 4, wherein the upper terminal and the lower terminal each include a guide surface portion that slidably contacts the first end portion or the second end portion,
parts of the contact surface portions of the upper terminal and the lower terminal constitute contact points that are relatively displaceable or relatively deformable in a thickness direction of the first end portion and the second end portion,
in a non-conductive state where the contact points do not contact the first end portion and the second end portion, the contact points are in contact with each other,
in a guiding state where each of the first end portion and the second end portion slides on the guide surface portion, the contact points are displaced or deformed in directions away from each other, and
in a conductive state where the first end portion and the second end portion contact the contact points, the contact points are in a pressurized contact with the first end portion or the second end portion.

6. The selector switch according to claim 1, wherein
the fixed conductive unit is provided with two parallel-use breaking points arranged in the predetermined direction, and
the fixed conductive unit is provided with the single series-use breaking point arranged between the two parallel-use breaking points in the predetermined direction.
